(19) United States
(12) Patent Application Publication
(10) Pub. No.: US 2015/0006550 A1
(43) Pub. Date: Jan. 1, 2015

(54) METHOD AND APPARATUS FOR MANAGING CONTENTS

(71) Applicant: Samsung Electronics Co., Ltd., Suwon-si (KR)

(72) Inventors: Hyungsuk HWANG, Hwaseong-si (KR); Youngkeun CHOI, Suwon-si (KR)

(21) Appl. No.: 14/315,781

(22) Filed: Jun. 26, 2014

(30) Foreign Application Priority Data
Jun. 27, 2013 (KR) 10-2013-0074392

(51) Int. Cl. G06F 17/30

(52) U.S. Cl. CPC G06F 17/30312
USPC 707/752; 707/736

(57) ABSTRACT

A method and an apparatus for managing contents are provided. The method includes determining a current time when a request for generating contents is made, determining a reference time corresponding to a standard time in a preset time zone based on the current time, storing the current time and the reference time in metadata of the contents, and storing the contents.

### CROSS-REFERENCE TO RELATED APPLICATION(S)

This application claims the benefit under 35 U.S.C. §119(a) of a Korean patent application filed on Jun. 27, 2013 in the Korean Intellectual Property Office and assigned Serial No. 10-2013-0074392, the entire disclosure of which is hereby incorporated by reference.

### TECHNICAL FIELD

The present disclosure relates generally to a method and an apparatus for managing contents. More particularly, the present disclosure relates to a method and an apparatus for managing contents which can manage contents generated in different time zones by at least one reference.

### BACKGROUND

Electronic devices (for example, a portable terminal, a mobile communication terminal, a smart phone, a tablet Personal Computer (PC), and the like) provide various functions which users require. For example, the portable terminal provides various functions, such as a call function, an image or video photographing function, a broadcast receiving function, an Internet access function, and the like. Further, the portable terminal may generate and store contents (a picture, a video, and the like). At this time, the portable terminal generally stores a time when the content is generated. The content generation time may be time information (hereinafter referred to as a current time) provided by the portable terminal.

When the portable terminal leaves one time zone and moves to another time zone, time information is generally reset according to the time zone to which the portable terminal has moved. Accordingly, the portable terminal stores a content generation time by using the reset time information. For this reason, the portable terminal may store content generation times different from actual content generation sequences. For example, when the portable terminal moves from a region A (using standard time of time zone “Greenwich Mean Time (GMT)-0”) to a region B (using standard time of time zone “GMT-9”) and generates contents, the contents generated in the region A may have an earlier generation time than that of the contents generated in the region B even though the contents generated in the region B are generated later. That is, a content storing method of the related art may have a problem in which the contents are stored in orders different from actual generation orders. Such a problem may occur since respective content generation times have different time reference values according to the movement of the time zone. Accordingly, a method of efficiently managing contents generated in different time zones is required.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for managing contents, which can manage contents generated in different time zones by at least one reference by storing a current time and a reference time and/or additional information together when the contents are generated.

Another aspect of the present disclosure is to provide a method and an apparatus for managing contents, which modify a reference time to correspond to a reference time zone preset for an electronic device and upload or download contents when the contents are transmitted and received between electronic devices, for example, when the contents are uploaded or downloaded between a server and a terminal

In accordance with an aspect of the present disclosure, a method of managing contents is provided. The method includes determining a current time when a request for generating contents is made, determining a reference time corresponding to a standard time in a preset time zone based on the current time, storing the current time and the reference time in metadata of the contents, and storing the contents.

In accordance with another aspect of the present disclosure, an apparatus for managing contents is provided. The apparatus includes an input unit configured to receive a content generation request, a controller configured to determine a current time when receiving the content generation request, to determine a reference time corresponding to a standard time in a preset time zone based on the current time, and to store the current time and the reference time in metadata of the contents, and a storage unit configured to store the contents requested to be generated and the metadata.

As described above, a method and an apparatus for managing contents according to an embodiment of the present disclosure can store a current time at a current position and a reference time at a predefined time zone as metadata. The present disclosure can manage contents generated in a plurality of time zones by at least one reference. For example, the present disclosure can manage and/or arrange the contents based on an actual generation order.

The present disclosure can modify a reference time of contents to a reference time in a time zone preset for an electronic device and upload or download the contents when the contents are transmitted and received between electronic devices, for example, when the contents are uploaded or downloaded between a server and a terminal. The present disclosure can manage contents uploaded to a plurality of electronic devices or servers having differently set reference times or contents downloaded from a plurality of electronic devices or servers based on a generation order automatically or manually according to a user's intention.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a content managing system according to an embodiment of the present disclosure;

FIG. 2 is a block diagram illustrating a configuration of an electronic device according to an embodiment of the present disclosure;

FIG. 3 is a flowchart illustrating a content managing method of an electronic device according to an embodiment of the present disclosure;

FIG. 4 is a flowchart illustrating a process of determining a current time according to an embodiment of the present disclosure;

FIG. 5 is a flowchart illustrating a content uploading method of an electronic device according to an embodiment of the present disclosure; and

FIG. 6 is a flowchart illustrating a content downloading method of an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The drawings and embodiments of the present disclosure provide particular examples to describe the technical matters of the present disclosure and help with an understanding of the present disclosure. However, they do not limit the scope of the present disclosure. It is obvious to those skilled in the art to which the present disclosure pertains that other modified embodiments based on the technical idea of the present disclosure besides the embodiments disclosed herein can be carried out.

In the following description, the term “electronic device” may be in reference to a mobile communication terminal, a smart phone, a tablet Personal Computer (PC), a hand-held PC, a Portable Multimedia Player (PMP), a Personal Digital Assistant (PDA), a notebook PC, or the like.

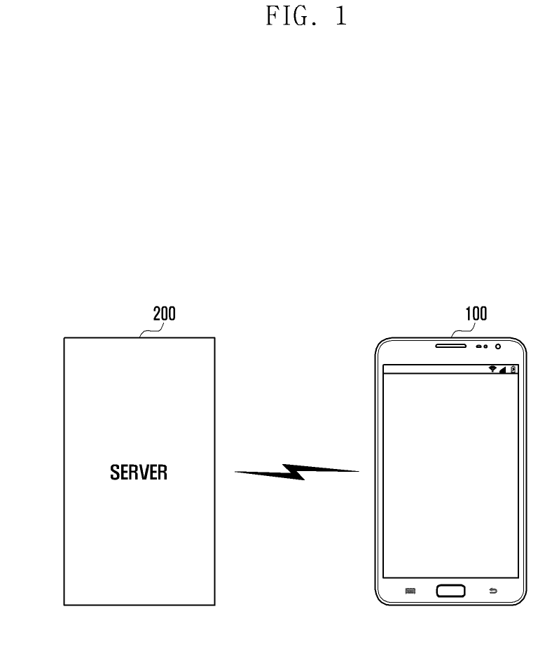

FIG. 1 illustrates a content management system according to an embodiment of the present disclosure.

Referring to FIG. 1, the content management system may include an electronic device 100 and a server 200.

The electronic device 100 may store contents (for example, an image, a picture, a video, a document, and the like). For example, the electronic device 100 may generate contents and store the generated contents, or download contents from the server 200 or another electronic device (not shown) and store the downloaded contents. The contents may include metadata. The metadata may include a current time and a reference time.

The current time may be used as the content generation time. The current time may be a terminal time provided by the electronic device 100 or a standard time of a region where the electronic device is located. In general, the terminal time is equal or similar to the standard time of the corresponding region, so that the current time may be the terminal time. Meanwhile, when the terminal time is different from the standard time of the corresponding region, for example, when they have a difference equal to or longer than a predetermined time, the electronic device 100 may determine the standard time as the current time. For example, when a region where the electronic device 100 is currently located applies daylight saving time, the electronic device 100 may determine the standard time of the corresponding region as the current time. For example, the electronic device 100 may receive current position information through a position information receiver, such as a Global Positioning System (GPS) module, and identify the standard time at the current position through a website providing the standard time. When the identified standard time does not match (or is not similar to) the terminal time, the electronic device 100 may determine the standard time as the current time. Alternatively, the electronic device 100 may determine the current time by compensating for the terminal time by the applied daylight saving time (For example, by one hour).

The reference time may be used as a reference value for managing the contents generated in different time zones. The reference time may be Greenwich Mean Time (GMT) in a preset time zone. The reference time may include at least one of a first reference time corresponding to the standard time at time zone “GMT 0” and a second reference time corresponding to the standard time at a particular time zone selected by the user.

The first reference time and the second reference time may be determined based on the current time and the position information. For example, when the current time is 21:00 on July 5 and the electronic device 100 is located in time zone GMT +9, the first reference time may be 12:00 on July 5. Meanwhile, when the particular region is time zone GMT +5, the second reference time may be 17:00 on July 5. The first reference time and/or the second reference time may be used for managing the contents generated in the different time zones according to actual generation orders.

The server 200 may store contents including the current time and the reference time. For example, the server 200 may be a cloud server which can synchronize the electronic device 100 and the contents to manage the contents. Particularly, the server 200 according to the embodiment of the present disclosure may set a reference time zone (hereinafter referred to as a reference time zone of the server) for managing contents generated in different time zones or contents uploaded from various electronic devices through one reference information. When the contents are uploaded from the electronic device 100, the server 200 may modify the reference time included in the metadata of the contents to correspond to the reference time zone of the server and upload the modified reference time, or a side of the electronic device 100 may modify the reference time included in the metadata of the contents to correspond to the reference time zone of the server and make a request for uploading the modified reference time. Alternatively, when the contents are downloaded to the electronic device 100 from the server 200, the electronic device 100 may modify the reference time included in the metadata of the contents to correspond to the reference time zone of the electronic device 100 and download the modified reference time, or a side of the server 200 may modify the reference time included in the metadata of the contents to correspond to the reference time zone of the electronic device 100 and make a request for downloading the modified reference time.

It has been described that the electronic device 100 modifies the reference time stored in the metadata of the contents to correspond to the server reference time zone when the electronic device 100 uploads the contents to the server 200. Further, it should be apparent to those skilled in the art that the electronic device 100 can modify the reference time stored in the metadata of the contents to correspond to the reference time zone of the electronic device 100 when the electronic device 100 downloads the contents from the server 200. The embodiment of the present disclosure can be applied to a case where the electronic device 100 transmits and/or receives contents to/from various electronic devices (for example, a notebook PC, a desktop PC, a mobile communication terminal, a smart phone, and the like).

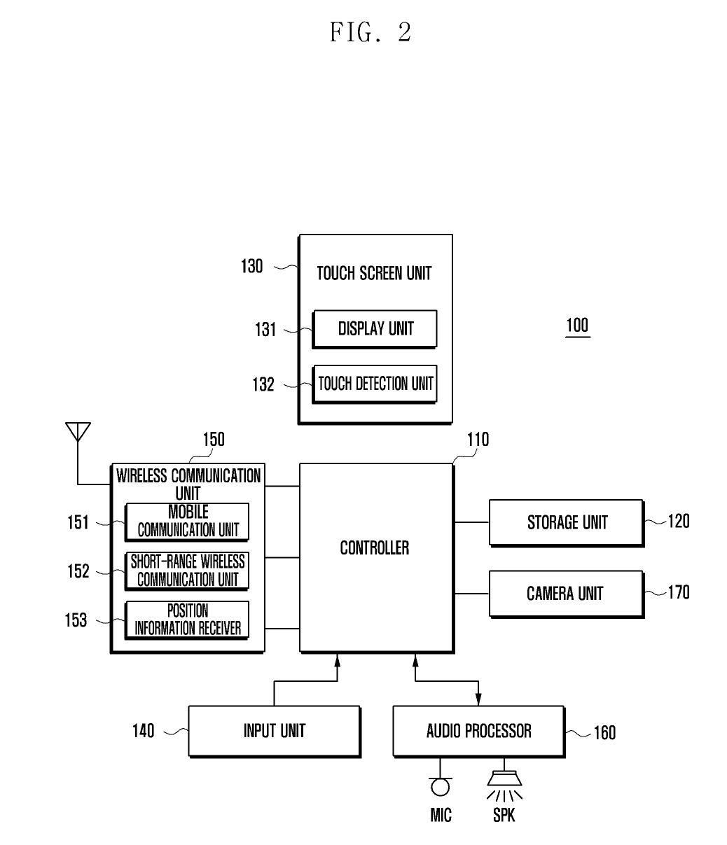

FIG. 2 is a block diagram illustrating a configuration of an electronic device according to an embodiment of the present disclosure.

Referring to FIG. 2, the electronic device 100 may include a controller 110, a storage unit 120, a touch screen 130, an input unit 140, a wireless communication unit 150, an audio processor 160, and a camera unit 170. The touch screen 130 may include a display unit 131 and a touch detection unit 132, and the wireless communication unit 150 may include a mobile communication unit 151, a short-range wireless communication unit 152, and a position information receiver 153.

The camera unit 170 is a device for photographing a subject, and may convert an image generated by photographing the subject to an electrical signal and store the electrical signal as digital data. The camera unit 170 may be implemented by a Charge Coupled Device (CCD) image sensor or a Complementary Metal Oxide Semiconductor (CMOS) image sensor. The camera unit 170 may support a function of photographing a picture or a video. Metadata of the picture or the video photographed through the camera unit 170 may store the current time and the reference time. Further, the metadata may include information on a photographing time, photographing conditions (an exposure value, a shutter speed, and the like), a photographing position, and the like.

The audio processor 160 may be connected with a speaker (SPK) for outputting an audio signal transmitted/received during a call, an audio signal included in a received message, or an audio signal according to a reproduction of an audio file stored in the storage unit 120. The audio processor 160 may also be connected with a microphone (MIC) for collecting a voice of the user or other audio signals. The audio processor 160 may output a sound effect according to the photographing of the picture or the video through the speaker under a control of the controller 110.

The wireless communication unit 150 may support a wireless communication function of the electronic device 100. To this end, the electronic device 100 may include the mobile communication unit 151 for supporting a mobile communication (for example, mobile communication of 2G, 3G, or 4G standard) function, the short-range wireless communication unit 152 for supporting a short-range wireless communication function, and the position information receiver 153 for supporting a position information receiving function.

The mobile communication unit 151 provides support such that voice communication and data communication are possible while the electronic device 100 is moving. The mobile communication unit 151 may support a mobile communication function for uploading contents to the server 200 or downloading contents from the server 200 under a control of the controller 110.

The short-range wireless communication unit 152 may support short-range wireless communications, such as Bluetooth, Zigbee, WiFi, WiFi Direct, Near Field Communication (NFC), and the like. The short-range wireless communication unit 152 may support a function of transmitting/receiving contents between the electronic device 100 and the server 200 or another electronic device under a control of the controller 110.

The position information receiver 153 may receive position information of the electronic device 100. For example, the position information receiver 153 may include at least one of a GPS module, WiFi Positioning Systems (WPSs) using position information of an Access Point (AP), and triangulation using a base station. The position information may be coordinate information including latitude, longitude, and altitude information. The position information of the electronic device 100 may be stored in the metadata of the contents. For example, when a picture is taken by the camera unit 170, position information received through the position information receiver 153 may be stored in exchange image format (Exif) data of the taken picture. Alternatively, the position information of the electronic device 100 may be used for identifying a time zone of a current position.

The input unit 140 may include a plurality of input keys and function keys for receiving number or character information and setting various functions. The function keys may include a direction key, a side key, and a shortcut key set to perform particular functions. Further, the input unit 140 may generate a key signal related to a user setting and a control of the function of the electronic device 100 and transmit the generated key signal to the controller 110. The input unit 140 may be configured by one or a combination of other input means, such as a qwerty keypad, a 3*4 keypad, a 4*3 keypad, a ball joystick, an optical joystick, a wheel key, a touch key, a touch pad, a touch screen, and the like. Meanwhile, when the electronic device 100 supports a full touch screen, the input unit 140 may include only a part of the function keys, such as a volume key, a power key, a menu key, a cancellation key, a home key, and the like. The input unit 140 may generate a content generation request signal, a content upload request signal, and a content download request signal and transmit the generated signals to the controller 110.

The touch screen 130 may perform an input function and a display function. To this end, the touch screen 130 may include the display unit 131 and the touch detection unit 132.

The display unit 131 displays information input by the user or information to be provided to the user as well as various menus of the electronic device 100. The display unit 131 may be formed by a Liquid Crystal Display (LCD), an Organic Light Emitting Diode (OLED), or an Active Matrix Organic Light Emitting Diode (AMOLED). The display unit 131 may provide various screens according to the use of the electronic device 100, for example, a home screen, a menu screen, a webpage screen, a call screen, and the like. Further, the display unit 131 may display a picture or video photographing screen, a content list displaying screen, and the like. The content list displaying screen may display contents, which have been generated in different time zones, arranged according to actual generation orders based on the reference time included in the metadata of the contents.

The touch detection unit 132 is a device for providing an input function and may generate a touch event when a touch input device, for example, a user's finger, a stylus pen, or an electronic pen contacts or approaches the electronic device and transmit the generated touch event to the controller 110. For example, the touch detection unit 132 may recognize the generation of the touch event through a change in a physical quantity (for example, capacitance, resistance, or the like) according to the contact or the approach of the touch input device. Since the touch detection unit 132 as described above is obvious to those skilled in the art, a detailed description thereof will be omitted. Particularly, the touch detection unit 132 according to the present disclosure may generate a touch signal making a request for photographing a picture or a video or a touch signal making a request for uploading or downloading contents and transmit the generated touch signal to the controller 110.

The storage unit 120 may store an Operating System (OS) of the electronic device 100 and application programs necessary for other optional functions, such as a sound reproduction function, an image or video reproduction function, a broadcast reproduction function, an Internet access function, a text message function, and the like. Further, the storage unit 120 may store various contents, for example, a video, a picture, a document, and the like. For example, the storage unit 120 may store metadata of contents. The metadata may include the current time and the reference time (first reference time and/or second reference time) in the time zone where the contents are generated. The metadata may further include information on a photographing time, photographing conditions (an exposure value, a shutter speed and the like), a photographing position, and the like. The metadata may be modified by the user.

The storage unit 120 may store a content management program for managing the contents generated in the different time zones by using one reference value (reference time). The content management program may include a routine of determining the reference time based on the current time of the position where the contents are generated (or stored) and storing the determined reference time in the metadata, a routine of controlling the current time determining process, and a routine of controlling the content uploading or downloading process.

The controller 110 may control overall operations of the electronic device 100 and a signal flow between internal blocks of the electronic device 100, and may perform a data processing function for processing data. For example, the controller 110 may be configured by a Central Processing Unit (CPU), an Application Processor (AP), or the like. The controller 110 may be implemented by a single core processor or a multi-core processor.

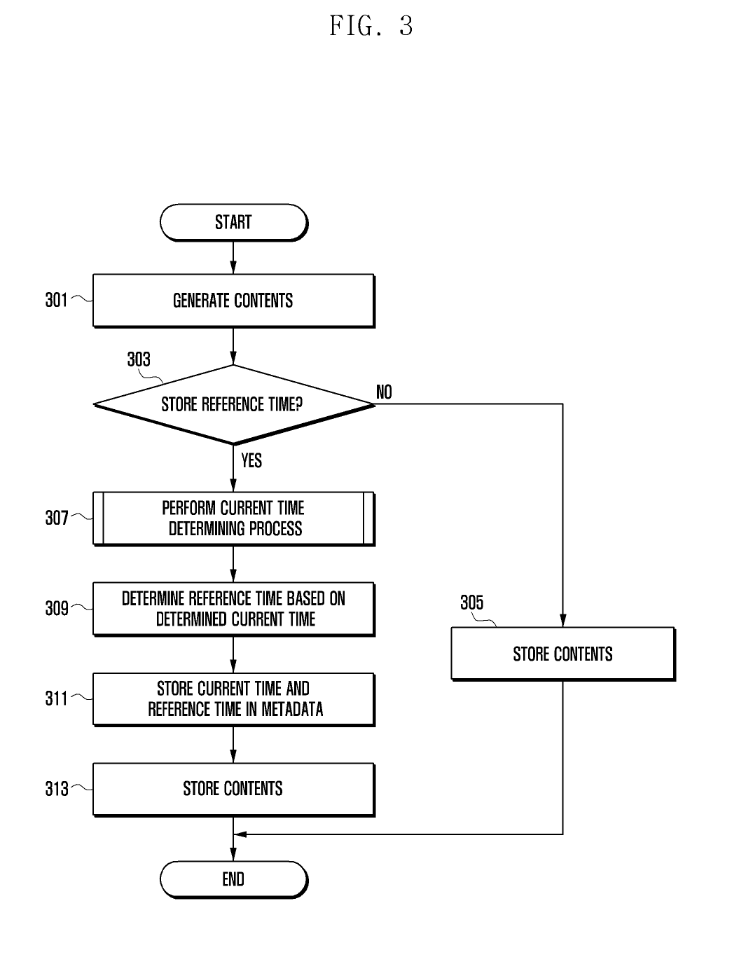

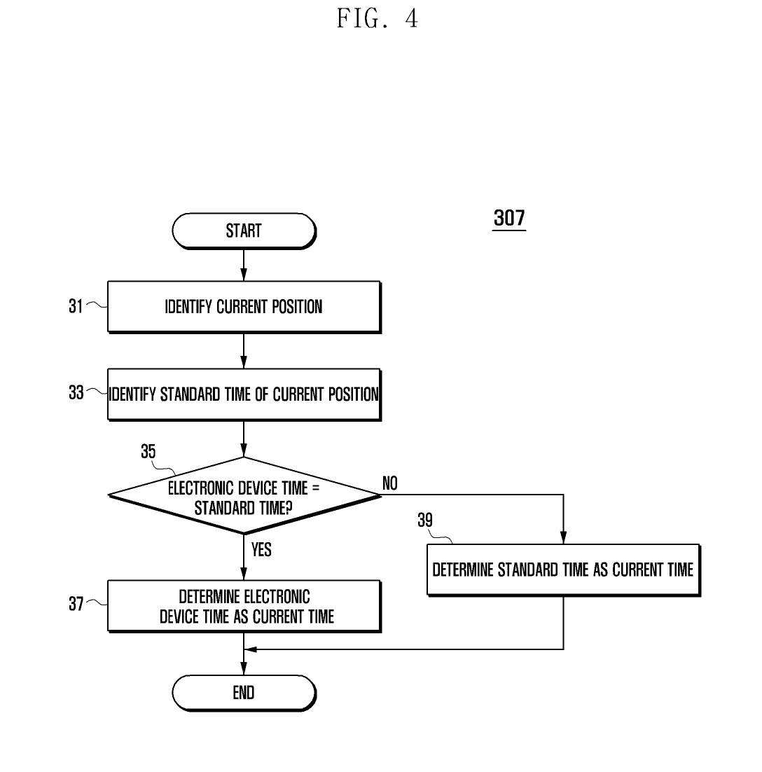

The controller 110 may manage the contents generated in the different time zones by using one reference value. To this end, the controller 110 may control to store the current time indicating the content generation time when the contents are generated and the reference time corresponding to the standard time in a preset time zone in the metadata. At this time, the reference time may include the first reference time corresponding to the standard time in time zone “GMT 0” and the second reference time corresponding to the standard time in a particular time zone selected by the user. A description of the controller 110 will be made below with reference to FIGS. 3 to 4.

The electronic device 100 may store the reference time corresponding to the standard time in the preset time zone even though the contents are generated in different time zones. Accordingly, the user of the electronic device 100 may conveniently manage contents generated in a plurality of time zones by using one reference value.

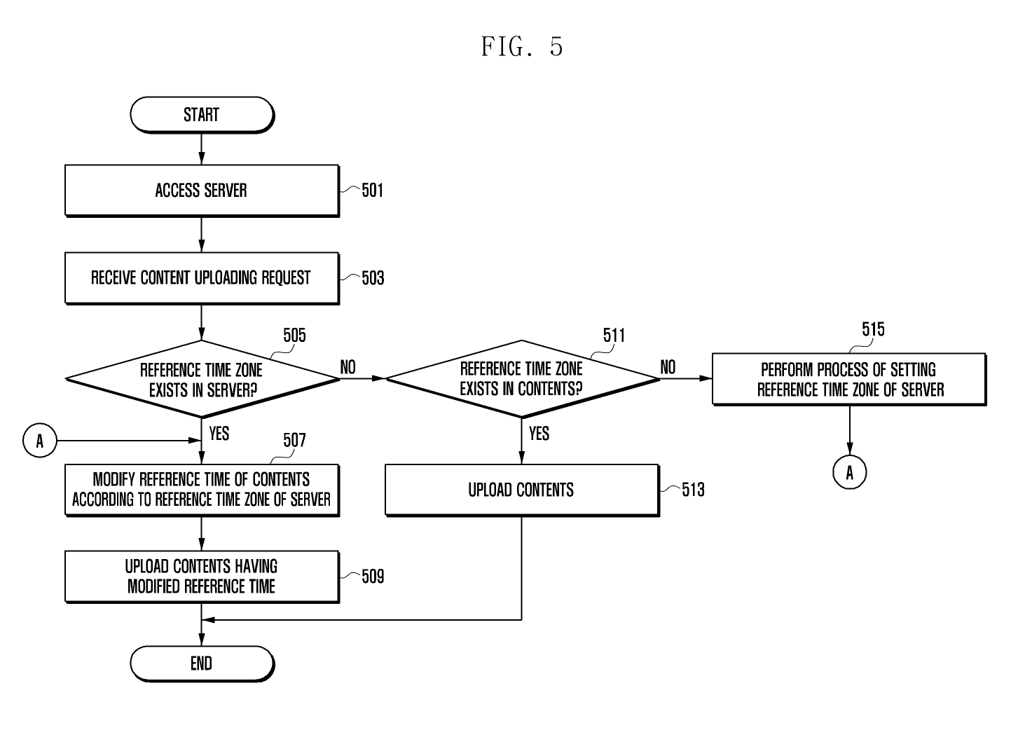

The controller 110 may identify whether the reference time zone of the server 200 exists when the contents are uploaded to the server 200. When the reference time zone of the server 200 exists, the controller 110 may modify the reference time of the contents to correspond to the reference time zone of the server 200 and upload the modified reference time. When the reference time zone does not exist, the controller 110 may identify whether the reference time zone of the contents of which the upload is requested exists. When the reference time zone of the contents exists, the controller 110 may upload the contents based on the reference time zone of the contents. When the reference time zone of the contents does not exist, the controller 110 may perform a process of setting the reference time zone of the server 200. A description thereof will be described below with reference to FIG. 5.

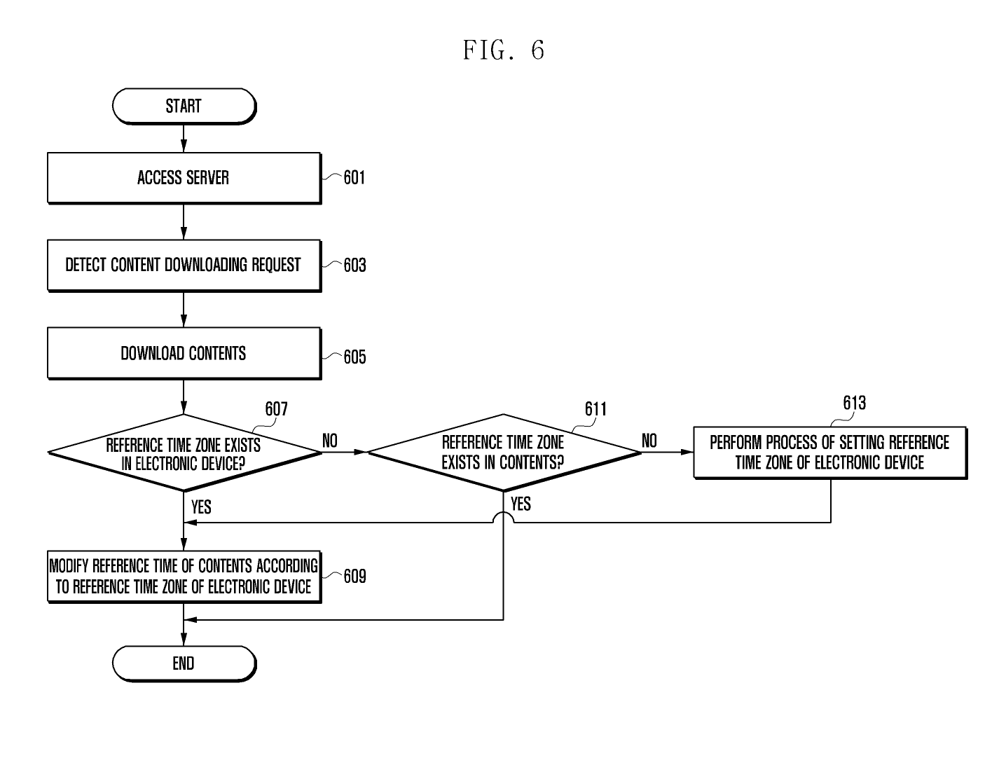

The controller 110 may identify whether the reference time zone of the electronic device 100 exists when the contents are downloaded from the server 200. When the reference time zone of the electronic device 100 exists, the controller 110 may modify the reference time of the downloaded contents according to the reference time zone of the electronic device 100. When the reference time zone of the electronic device 100 does not exist, the controller 110 may identify whether the reference time zone of the downloaded contents exists. When the reference time zone of the contents exists, the controller 110 may store the downloaded contents without any modification. When the reference time zone of the contents does not exist, the controller 110 may perform a process of setting the reference time zone of the electronic device 100. A description thereof will be described below with reference to FIG. 6.

Meanwhile, although not illustrated in FIG. 2, the electronic device 100 may further selectively include components having additional functions, such as a sensor module for collecting various pieces of sensor information, a broadcast receiving module for receiving a broadcast, a digital sound source reproduction module such as an MP3 module, and a voice recognition module for supporting a voice recognition function. While all the components cannot be listed since they are variously modified according to the convergence trend of digital devices, the electronic device 100 according to the present disclosure may further include components at the equivalent level to the above listed components.

FIG. 3 is a flowchart illustrating a method of managing contents of the electronic device according to an embodiment of the present disclosure.

Referring to FIG. 3, the controller 110 may generate contents in operation 301. For example, the controller 110 may control photographing of a picture or a video by using the camera unit 170. Alternatively, the controller 110 may control document writing.

The controller 110 may identify whether the reference time is stored in operation 303. When the reference time is not stored, the controller 110 may proceed to operation 305 to store the contents. For example, as in the related art, the controller 110 may store the terminal time provided by the terminal as the content generation time in the metadata of the contents and store the contents.

In contrast, when the reference time is stored, the controller 110 may proceed to operation 307 to perform a current time determining process. A description of the current time determining process will be provided below with reference to FIG. 4.

The controller 110 may determine the reference time based on the determined current time in operation 309. At this time, the reference time may include the first reference time corresponding to the standard time in a Greenwich region and the second reference time corresponding to the standard time in a particular time zone set by the user. For example, when the current time of the region using the standard time in time zone “GMT −10” is 11:00 on July 5, the first reference time is set as the standard time in time zone “GMT 0”, and the second reference time is set as the standard time in time zone “GMT +9”, the first reference time may be 21:00 on July 5 and the second reference time may be 6:00 on July 6.

When the reference time is determined, the controller 110 may store the current time and the reference time in metadata in operation 311 and store the content in operation 313. For example, metadata of the stored content may include the current time “11:00 on July 5”, the first reference time “21:00 on July 5”, and the second reference time “6:00 on July 6”.

The electronic device 100 may further store the reference time as well as the current time when the content is generated and may easily manage contents generated in different time zones by using the reference time. For example, when contents are arranged using the reference time, the contents are arranged according to an actual generation order. Accordingly, the embodiment of the present disclosure can address the problem of the related art in which the contents are arranged differently from the actual generation order.

It has been described as an example that the electronic device generates or uploads contents. However, the embodiment of the present disclosure may be applied to a case where the contents are downloaded from the server 200 or other electronic devices. For example, when contents including the reference time are downloaded, the controller 110 may modify the reference time included in metadata of the content to correspond to a time zone of a terminal.

FIG. 4 is a flowchart illustrating a process of determining a current time according to an embodiment of the present disclosure.

Referring to FIG. 4, the controller 110 may identify a current position in operation 31. The current position may be identified through the position information receiver 153, such as a GPS module. Alternatively, the current position may be identified through a WiFi Positioning System (WPS) using position information of an AP and triangulation using a base station.

The controller 110 may identify the standard time of the current position in operation 33. For example, the controller 110 may identify the standard time of the current position by accessing a website providing the standard time.

The controller 110 may identify whether the terminal time and the standard time match each other in operation 35. The terminal time may be transmitted from the base station or provided using a Real Time Clock (RTC) within the electronic device 100.

When the terminal time and the standard time match each other, the controller 110 may determine the terminal time as the current time in operation 37. In contrast, when the terminal time and the standard time do not match each other, the controller 110 may determine the standard time identified in operation 33 as the current time in operation 39.

The aforementioned current time determining process is performed to prevent the reference time of contents generated in a particular region applying the daylight saving time from having an error by an application time of the daylight saving time (for example, one hour). Accordingly, the electronic device 100 may manage (for example, arrange) contents generated in various time zones with the same reference (first reference time or second reference time).

FIG. 5 is a flowchart illustrating a content uploading method of an electronic device according to an embodiment of the present disclosure.

Referring to FIG. 5, the controller 110 of the electronic device 100 may access the server 200 in operation 501. The server 200 may be a cloud server. The controller 110 may receive a content upload request in operation 503. When receiving the content upload request, the controller 110 identifies whether a reference time zone exists in the server 200 in operation 505. Meanwhile, the order of operations 501 and 503 may be changed or the operations may be performed concurrently. That is, the controller 110 may access the server 200 when receiving the content upload request.

When the reference time zone exists in the server 200, the controller 110 may modify the reference time included in metadata of the content according to the reference time zone of the server 200 in operation 507 and upload the content having the modified reference time to the server 200 in operation 509. For example, when the reference time of the server 200 is set as “GMT +9” and the reference time of the content to be uploaded is “GMT 0 10:00 on July 5”, the controller 110 may modify the reference time of the content to “GMT +9, 19:00 on July 5” and upload the content having the modified reference time.

Meanwhile, when the reference time zone does not exist in the server 200 in operation 505, the controller 110 may identify whether the reference time zone exists in the metadata of the content in operation 511. When the reference time zone exists in the metadata of the content, the controller 110 may upload the content requested to be uploaded to the server 200 without any modification of the reference time in operation 513. In contrast, when the reference time zone does not exist in the metadata of the content in operation 511, the controller 110 may perform a process of setting the reference time zone of the server 200 in operation 515. When the reference time zone of the server 200 is set, the controller 110 may perform the above described process in operation 507.

Meanwhile, although it has been described that the electronic device 100 uploads the content to the server 200 after modifying the reference time of the content, the present disclosure is not limited thereto. For example, in another embodiment of the present disclosure, the electronic device 100 transmits reference time zone information when uploading the content. When the upload of the content is completed, the reference time of the content may be modified according to the reference time zone of the electronic device 100 which the server 200 receives.

FIG. 6 is a flowchart illustrating a content downloading method of an electronic device according to an embodiment of the present disclosure.

Referring to FIG. 6, the controller 110 of the electronic device 100 may access the server 200 in operation 601. For example, the controller 110 may access the server 200 which stores contents, such as a cloud server, a web server, or the like. When the access to the server 200 is made, the controller 110 may display a list of the contents stored in the server 200 on the display unit 131.

The controller 110 may detect a content download request in operation 603 and download contents requested to be downloaded in operation 605. For example, the user of the electronic device 100 may select at least one content from the list and input a download command of the selected content.

The controller 110 may identify whether the reference time zone of the electronic device 100 exists in operation 607. When the reference time zone of the electronic device 100 exists, the controller 110 may modify the reference time of the downloaded content according to the reference time zone of the electronic device 100 in operation 609. For example, when the reference time zone of the electronic device 100 is set as “GMT +9” and the reference time of the content downloaded from the server 200 is “GMT 0, 10:00 on July 5”, the controller 110 may modify the reference time of the content to “GMT +9, 19:00 on July 5” and download the content having the modified reference time.

When the reference time zone of the electronic device 100 does not exist in operation 607, the controller 110 may identify whether the reference time zone exists in the content in operation 611. When the reference time zone of the content exists in operation 611, the controller 110 may store the downloaded content without any modification of the reference time of the downloaded content and terminate the content downloading process. In contrast, when the reference time zone of the content does not exist in operation 611, the controller 110 may perform a process of setting the reference time zone of the electronic device 100 in operation 613. When the reference time zone of the electronic device 100 is completely set, the controller 110 may modify the reference time of the downloaded content according to the reference time zone of the electronic device 100 and store the content in operation 609.

Meanwhile, although it has been described that the electronic device 100 modifies the reference time of the content after downloading the content, the present disclosure is not limited thereto. For example, in another embodiment of the present disclosure, when the download of the content is requested, the server 200 may identify the reference time zone of the electronic device 100 and modify the reference time of the content according to identified the reference time zone of the electronic device 100, and then transmit the content to the electronic device 100.

The content managing method according to various embodiments of the present disclosure may be implemented in a form of a program command which can be executed through various computer means and may be recorded in a computer-readable recording medium. The computer-readable recording medium may include a program command, a data file, and a data structure alone or a combination thereof. Meanwhile, the program command recorded in the recording medium is specially designed and configured for the present disclosure, but may be used after being known to those skilled in computer software fields. The computer-readable recording medium includes magnetic media such as hard disks, floppy disks and magnetic tapes, optical media such as a Compact Disc Read-Only Memory (CD-ROM) and a Digital Versatile Disc (DVD), magneto-optical media such as floptical disks, and hardware devices such as a Read-Only Memory (ROM), a Random Access Memory (RAM) and a flash memory, which are specially configured to store and perform program commands. Further, the program command includes a machine language code generated by a compiler and a high-level language code executable by a computer through an interpreter and the like. The hardware devices may be configured to operate as one or more software modules to perform the operations of the present disclosure.

Electronic devices having a touch sensor unit according to the various embodiments of the present disclosure have been described above with reference to the drawings and specific terms have been used. However, the description and terms have been used in a general meaning merely to easily describe the technical contents of the present disclosure and to help the understanding of the present disclosure. The present disclosure is not limited to the various embodiments as described above. That is, it is apparent to those skilled in the art that other various embodiments based on the technical idea of the present disclosure can be implemented.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of managing contents, the method comprising:
determining a current time when a request for generating contents is made;
determining a reference time corresponding to a standard time in a preset time zone based on the current time;
storing the current time and the reference time in metadata of the contents; and
storing the contents.

2. The method of claim 1, wherein the reference time includes at least one of a first reference time corresponding to a standard time of a reference time zone and a second reference time corresponding to a standard time of a particular time zone selected by a user.

3. The method of claim 1, wherein the determining of the current time comprises:
identifying whether a terminal time provided by an electronic device matches a standard time at a current position;
when the terminal time matches the standard time, determining the terminal time as the current time; and
when the terminal time does not match the standard time, determining the standard time as the current time.

4. The method of claim 1, wherein the stored contents are arranged and displayed based on the current time or the reference time.

5. The method of claim 1, further comprising:
receiving a request for uploading the stored contents to a server;
identifying whether a reference time zone of the server exists; and
when the reference time zone of the server exists, modifying the reference time stored in the metadata of the contents to correspond to the reference time zone of the server and uploading the contents.

6. The method of claim 5, further comprising:
when the reference time zone of the server does not exist, identifying whether the reference time zone exists in the metadata of the contents requested to be uploaded; and
when the reference time zone exists in the metadata, uploading the contents requested to be uploaded to the server without any modification of the reference time.

7. The method of claim 6, further comprising, when the reference time zone does not exist in the metadata, performing a process of setting the reference time zone of the server.

8. The method of claim 1, further comprising:
downloading contents from the server by an electronic device;
identifying whether a reference time zone of the electronic device exists; and
when the reference time zone of the electronic device exists, modifying the reference time stored in the metadata of the contents to correspond to the reference time zone of the electronic device.

9. The method of claim 8, further comprising, when the reference time zone of the electronic device does not exist, identifying whether the reference time zone exists in the metadata of the downloaded contents;
when the reference time zone exists in the metadata, storing the downloaded contents without any modification of the reference time; and
when the reference time zone does not exist in the metadata, performing a process of setting the reference time zone of the electronic device.

10. The method of claim 1, wherein the metadata is data in an EXchangeable Image Format (EXIF).

11. An apparatus for managing contents, the apparatus comprising:
an input unit configured to receive a content generation request;
a controller configured to determine a current time when receiving the content generation request, to determine a reference time corresponding to a standard time in a preset time zone based on the current time, and to store the current time and the reference time in metadata of the contents; and
a storage unit configured to store the contents requested to be generated and the metadata.

12. The apparatus of claim 11, wherein the reference time includes at least one of a first reference time corresponding to a standard time of a reference time zone and a second reference time corresponding to a standard time of a particular time zone selected by a user.

13. The apparatus of claim 11, wherein, when the current time is determined, the controller identifies whether a terminal time provided by an electronic device matches a standard time at a current position, determines the terminal time as the current time when the terminal time matches the standard time, and determines the standard time as the current time when the terminal time does not match the standard time.

14. The apparatus of claim 11, wherein the contents are arranged and displayed based on the current time or the reference time.

15. The apparatus of claim 11, wherein, when receiving a request for uploading the contents to a server, the controller identifies whether a reference time zone of the server exists, and modifies the reference time stored in the metadata of the contents to correspond to the reference time zone of the server and uploads the contents when the reference time zone of the server exists.

16. The apparatus of claim 15, wherein, when the reference time zone of the server does not exist, the controller controls to identify whether the reference time zone exists in the metadata of the contents requested to be uploaded, and to upload the contents requested to be uploaded to the server without any modification of the reference time when the reference time zone exists in the metadata.

17. The apparatus of claim 16, wherein, when the reference time zone does not exist in the metadata, the controller controls to perform a process of setting the reference time zone of the server.

18. The apparatus of claim 11, wherein, when the contents are downloaded from the server, the controller controls to identify whether a reference time zone of the electronic device exists, and to modify the reference time stored in the metadata of the contents to correspond to the reference time zone of the electronic device when the reference time zone of the electronic device exists.

19. The apparatus of claim 18, wherein, when the reference time zone of the electronic device does not exist, the controller controls to identify whether the reference time zone exists in the metadata of the downloaded contents, to store the downloaded contents without any modification of the reference time when the reference time zone exists in the metadata, and to perform a process of setting the reference time zone of the electronic device when the reference time zone does not exist in the metadata.

20. The apparatus of claim 11, wherein the metadata is data in an EXchangeable Image Format (EXIF).
